(19) United States
(12) Patent Application Publication
(10) Pub. No.: US 2003/0008048 A1
(43) Pub. Date: Jan. 9, 2003

(54) Methods and compositions for helping the body resist the effects of the aging process

(76) Inventors: David Winston, Montereye, CA (US); Steven Goldber, Monterey, CA (US)

Correspondence Address: PATENT ADMINISTRATOR, KATTEN MUCHIN ZAVIS ROSENMAN, Suite 1600, 525 West Monroe Street, Chicago, IL, 60661-3693, US

(21) Appl. No.: 10/163,369

(22) Filed: Jun. 7, 2002

Related U.S. Application Data
(60) Provisional application No. 60/296,459, filed on Jun. 8, 2001.

(51) Int. Cl. A23L 1/236

(52) U.S. Cl. 426/548

(57) ABSTRACT

A dietary nutritional supplement for helping the body resist the effects of the aging process. The composition is designed to help a user feel healthier, look his or her best, and increase the ability to maintain a full, more active life as the person ages. The composition is a two-part composition, comprising a lipid-soluble portion in soft gel cap form and a water-soluble portion in hard shell capsule or tablet form.

### CROSS REFERENCE TO RELATED APPLICATIONS

The present application claims priority to U.S. Provisional Application Serial No. 60/296,459, filed Jun. 8, 2001, the disclosure of which is incorporated by reference herein.

### FIELD OF THE INVENTION

The present invention relates to the art of natural nutritional dietary supplements. In particular, the present invention relates to a nutritional dietary supplement combining Western and Eastern herbs, vitamins, minerals and botanicals with modern dietary science. More particularly, the present invention relates to a nutritional dietary supplement which combines ingredients in a manner and device which when ingested on a regular daily basis helps the body resist the effects of the aging process.

### BACKGROUND

As people get older, their general health declines. For example, the body may have a more difficult time restoring itself, recovery from illness may occur more slowly, memory lapses may occur, sleep patterns may become more irregular, circulatory and cardiac systems may be less optimal and the general performance of organs declines. These physiological changes are thought to be related to cell damage and a decreased efficiency in cell rejuvenation, both of which occur as people age.

According to the one of the predominant theories of aging, free radical damage is considered to be one of the main causes of aging. Free radicals are extremely reactive chemical species with unpaired electrons that cause injury to cells and disrupt their functions. Free radicals arise spontaneously in the human body due to biochemical reactions involving oxygen. They include such species as the peroxides and superoxides. Certain lifestyle habits are associated with enhanced free radical production in the body. For example, smoking greatly increases the requirement for antioxidants in the body, which are required to combat the numerous toxins and free radicals in tobacco smoke.

As a consequence of the aging process, people look and feel tired. Such signs of aging can have a negative psychological impact. People feel less attractive and think others are looking at them in a less favorable way. Their self-confidence begins to drop. If the aging process goes unchecked, the physiological changes may begin to occur more rapidly, the signs of aging may begin to show more rapidly, and psychological well-being may begin to decline more rapidly. Due to the numerous free radical challenges to our health, and the many adverse effects of free-radical induced aging, many nutritional experts advocate taking dietary supplements of antioxidants on a daily basis to insure adequate levels in the body for optimal protection.

The aging of smears of fresh peripheral blood may be used as a model system for studying at the cellular level aging associated with free radical attack. The stability and morphology of red blood cells (RBCs) in peripheral blood smears is affected by oxidative stress due to free radical attack on the cells. Free radical species can oxidize and damage the proteins and lipids within the RBC and cause crenation, distortion of the normal shape of the cell. Normal RBCs are smooth, round, biconcave disks. RBCs that have undergone attack by free radicals become irregular in shape, and often wrinkled or spiked in appearance. In extreme cases, they appear as spheres covered with short, sharply pointed projections known as “echinocytes.” RBCs attacked by free radicals may also lyse (or break down), leading to the appearance of rounded shadow cells called “ghosts,” which are cell membranes devoid of contents.

Peripheral blood removed from the body undergoes accelerated aging caused, in part, by free radical attack due to exposure to the oxygen in air. In the body, older RBCs are more prone to undergo shape changes, and they exhibit faster lysis than younger cells. Most of the RBCs in peripheral blood smears, unprotected by antioxidants, can be readily observed under the microscope to show morphology changes, over a period of several hours, due to free radical attack similar to those observed in older RBCs found in native blood.

Antioxidants are required to quench free radical reactions. In this way, they protect each cell in the body from premature aging and death. Some of the natural antioxidants in the body are manufactured in the tissues. Other antioxidants such as vitamin C, vitamin E, selenium, and many others come from dietary intake. However, many of the natural antioxidants in food such as vitamin C are destroyed by cooking, food processing, or food storage. Moreover, the requirement for antioxidants is greater today than ever before due to increased environmental pollution, because we are exposed to greater amounts of free-radical promoting chemicals such as ozone and nitrogen oxides.

There is a need in the art for a convenient and efficient means for a user to obtain dietary anti-oxidant protection.

### SUMMARY OF THE INVENTION

The present invention provides a nutritional dietary supplement which, when ingested on a regular daily basis, helps the body resist the effects of the aging process. The nutritional dietary supplement is a unique mixture of active ingredients contained, preferably, in a unique two-part delivery format.

According to some embodiments of the invention, the active ingredients include Vitamin C, mixed Carotenoids, mixed tocopherols and tocotrienols, Bilberry extract, Chlorella, Green Tea Extract, and Coenzyme Q-10. In some embodiments, the active ingredients may also include one or more of Alpha Liphoic Acid, N-Acetyl-L-Cysteine, Amla Extract, Hawthorne Berry Extract, Reishi Mushroom Extract, Rosemary Extract, Garlic Extract, Ginkgo Biloba Extract, Grape Seed Extract, Ginger Extract, Pipali Long Pepper Extract, Astaxanthin, Lutein, and Lycopene. The term “Astaxanthin” is used interchangeably with the phrase “Astaxanthin Complex” hereinafter.

The two-part delivery format preferably comprises a hard shell capsule or tablet containing water-soluble ingredients and a soft gel capsule containing lipid-soluble ingredients.

In some embodiments, the hard shell capsule or tablet contains at least Vitamin C, Bilberry extract, Chlorella, and Green Tea extract. In other embodiments, the hard shell capsule also includes at least one or more of N-Acetyl-L-Cysteine, Amla extract, Hawthorn Berry extract, Reishi Mushroom extract, Rhodiola Rosea extract, Rosemary extract, Garlic extract, Ginkgo Biloba extract, Grape Seed extract, Jiaogulan extract, Ginger extract and Pipali Long Pepper extract. In some embodiments, the soft gel capsule contains at least mixed Carotenoids, mixed tocopherols and tocotrienols, and Coenzyme Q-10. In other embodiments, the soft gel capsule also includes at least one or more of Astaxanthin, Lutein, and Lycopene.

In some embodiments of the invention, the nutritional supplement is a two-part composition, comprising: a first portion and a second portion, wherein the first portion comprises: at least one first component chosen from Vitamin C, Schisandra Berry, Raspberry, Strawberry, Pomegranate, and Elderberry; at least one second component chosen from Bilberry and Blueberry; Chlorella; and at least one third component chosen from Green Tea and Dark Chocolate; and wherein the second portion comprises: at least one first component chosen from mixed Carotenoids, Echinacea, and Goldenseal; at least one second component chosen from mixed tocopherols and tocotrienols, Zinc, and Selenium; and Coenzyme Q-10. In some embodiments the first portion further comprises Alpha Liphoic acid and Chlorella. In some embodiments, the first portion further comprises Alpha Liphoic acid, Chlorella and at least one additional component chosen from N-Acetyl-L-Cysteine, Amla extract, Hawthorne Berry extract, Reishi Mushroom extract, Rhodiola Rosea extract, Garlic extract, Ginkgo Biloba extract, Grape Seed extract, Jiaogulan extract, L-Carnitine, Sage, Thyme, Basil, Tumeric, Oregano, Ginseng, Pine Bark, Ginger extract, Pipali Long Pepper, Spinach Powder, and Tomato Powder; and the second portion further comprises at least one additional component chosen from Astaxanthin, Lutein, and Lycopene.

The first portion and second portion are preferably separately contained. In some embodiments, the first portion is contained in a hard shell capsule or tablet and the second portion is contained in a soft gel capsule.

The present invention also provides a method for resisting the effects of aging. A method in accordance with the present invention comprises daily ingesting or administering a two-part nutritional supplement, wherein the first part of the supplement comprises: at least one first component chosen from Vitamin C, Schisandra Berry, Raspberry, Strawberry, Pomegranate, and Elderberry; at least one second component chosen from Bilberry and Blueberry; and at least one third component chosen from Green Tea and Dark Chocolate; and wherein the second part of the supplement comprises: at least one first component chosen from mixed Carotenoids, Echinacea, and Goldenseal; at least one second component chosen from mixed tocopherols and tocotrienols, Zinc, and Selenium; and a third component Coenzyme Q-10.

In some embodiments, the method comprises ingesting or administering at least two doses of the first part and at least two doses of the second part per day. In some embodiments, the method comprises ingesting at least two to four doses of the first part and at least two to four doses of the second part per day.

In some embodiments, the method comprises taking the two doses of the first part of the supplement and the two doses of second part of the supplement at once. In some embodiments, the method comprises taking at least a single dose of the first part of the supplement and at least a single dose of the second part of the supplement in the morning and thereafter taking at least a single dose of first part of the supplement and at least a single dose of the second part of the supplement in the afternoon.

Preferably the first part of the supplement is in the form of a hard shell capsule or tablet and the second part of the supplement is in the form of a soft gel capsule. In one embodiment, the two soft gel caps and two hard shell capsules or tablets can be provided in convenient one-serving packets and the four portions (i.e. two soft gel caps and two hard shell capsules or tablets) can be taken at one time or twice per day—half in the morning and half in the afternoon.

The present invention further encompasses a composition and method for enhancing the preservation of collected blood products. Collection and storage of blood products is a vital component of modern medical practice, and improved methods for preserving those vital products are desirable. A formulation of the present invention is useful in the preservation of collected blood by enhancing the lifespan of individual RBCs within the collected blood, and a the present invention is also directed toward a method of preserving collected blood by the ingestion by blood donors of an antioxidant formulation of the present invention prior to donating blood. In an alternative embodiment, the useful lifespan of previously collected blood may be increased by the addition of a formulation of the present invention to the collected blood.

Additionally, increasing the lifespan of individual RBCs in a patient's bloodstream will have the effect of enhancing the total amount of RBCs in the blood of a person predisposed to anemic conditions. Likewise, treatment of acute anemic conditions is affected by increasing the lifespan of the RBCs present in the user's blood. Therefore, a further embodiment of the present invention is directed towards a composition and method for preventing and/or treating anemic conditions.

### BRIEF DESCRIPTION OF THE DRAWINGS

FIG. 1 represents the RBC morphology for J H, 56, female nonsmoker, under 4 conditions of supplementation.

FIG. 2 represents the RBC morphology for B F, 40, male nonsmoker, under 4 conditions of supplementation.

FIG. 3 represents the RBC morphology for K G, 57, female smoker, under 4 conditions of supplementation.

FIG. 4 represents the RBC morphology for D K, 47, male smoker, under 4 conditions of supplementation.

### DETAILED DESCRIPTION

The present invention relates generally to products for and methods of helping the body resist the effects of the aging process.

The products comprise a unique combination of natural and synthetic active ingredients, including herbs, vitamins, minerals, and botanicals, which operate synergistically to enhance the effect of individual actives, helping to keep a person feeling healthy and looking their best without having to take excessive or unmanageable amounts of the actives.

The unique combination of ingredients, when ingested on a daily basis over a period of time, is designed to help many elements of the body and its functions. For example, it can help one or more of the following: prevent age related cellular damage, improve immune function, promote general mental function, slow down the physical manifestations of aging that may appear on the outside of the body, assist with the circulatory system, maintain healthy ranges of chemicals levels in your blood, capillary stability, and appropriate blood pressure levels, assist with physical mobility, visual acuity, maintain hearing, improve age related changes in cognitive function, the peripheral nervous system, the digestive system as well as support urinary and excretion systems and general functioning of organs. Preferably, products according to the invention can help with most or all of the above listed elements of the body and functions. Such assistance can help give one a feeling of increased energy and rejuvenation as well as a sense of well being. Thus, it gives one a sense of emotional and psychological well being that enhances and improves one's appearance and the perception of one's state of being by others.

Without being bound by theory, generally, the product is thought to function by efficiently providing additional nourishment, support, and strength to cells in every area of the body; certain ingredients are thought to act cooperatively, directing the flow of active ingredients to specific areas of the body, creating less waste and thus a greater benefit than was otherwise expected. The additional nourishment, support, and strength rejuvenates cells and protects them from damage associated with the aging process. Protected cells keep a person looking and feeling healthy.

The present invention comprises a mixture of four categories of compounds: a first type which is thought to aid the immune system; as well as the general cell structure of the body; a second type which is thought to aid the central nervous system; a third type which is thought to aid the circulatory system; and a fourth type which is thought to aid the digestive system.

Non-limiting examples of compounds which can enhance the immune system as well as aid the general cell structure of the body include Vitamin C, Bilberry extract, Chlorella, Green Tea extract, Amla extract, Garlic extract, mixed Carotenoids, mixed tocopherols and tocotrienols, Lutein, Lycopene, Coenzyme Q-10, Astaxanthin, and Reishi Mushroom extract. Non-limiting examples of compounds which can aid the central nervous system include Vitamin C, mixed Carotenoids, Astaxanthin, Lutein, Alpha Lipoic acid, Amla extract, Bilberry extract, Green Tea extract, Rhodiola Rosea extract, Rosemary extract, and Ginkgo Biloba extract. Non-limiting examples of compounds which can aid the circulatory system include Coenzyme Q-10, Astaxanthin, Alpha Lipoic acid, Bilberry extract, Green Tea extract, Amla extract, Hawthorne Berry extract, Rosemary extract, Garlic extract, Grape Seed extract, and Jiaogulan extract. Non-limiting examples of compounds which can aid the digestive system include N-acetyl-L-Cysteine, Amla extract, Ginger extract, and Pipali Long Pepper extract.

As can be seen from the examples provided above, a compound may belong to one or more category. More specifically, for example, Vitamin C (as Magnesium Ascorbate, available from American Ingredients, LLC) can enhance the immune system (e.g. can reduce the symptoms of colds and shorten length of illness) and promote visual health (e.g. may reduce risk of cataracts and macular degeneration). Alpha Lipoic Acid, available from Technical Sourcing International, Inc., may reduce the risk of age-related hearing loss, may retard development of diabetic cataracts, and can reduce symptoms of cardiac and diabetic neuropathy.

Bilberry Extract (Vaccinium myrtillus), available from Brucia Plant Extracts, contains large amounts of anthrocyanins and bioflavinoids, which among other things aid the general cell structure of the body. These are naturally-occurring antioxidant compounds, which appear to correlate with reduced oxidative and age related cellular damage, particularly to the immune and central nervous systems. The anthrocyanins and bioflavinoids are also natural pigments, which act as powerful antioxidants and are believed to reduce the oxidative stress upon the immune and nervous system. Bilberry extract can also reduce the risk of varicose veins, reduce the risk of cataracts and macular degeneration, and has also been found to reduce eye fatigue and appears to work well in strengthening the circulatory and peripheral nervous systems.

Chlorella (Chlorella pyrenoidosa), available from Maypro Industries, is a fresh water green algae that has an extremely high concentration of chlorophyll. It also contains B vitamins, as well as vitamins C, E, and several dietary minerals. As an herbal remedy, Chlorella has also been used as a treatment for viral infections, and, in Chinese medicine, as a treatment for growths and tumors.

Green Tea Extract, available from Brucia Plant Extracts, may reduce the risk of liver and heart disease. Green Tea also contains large amounts of anthrocyanins and bioflavinoids. As discussed above, these are naturally-occurring antioxidant compounds that appear to correlate with reduced oxidative and age related cellular damage, particularly to the immune and central nervous systems.

N-Acetyl-L-Cysteine, available from Compound Solutions, Inc., is an amino acid derivative which has been found to have beneficial effects in reducing the attacks of chronic bronchitis and to help with the digestive and excretory systems.

Amla Extract (Emblica officinalis), available from Brucia Plant Extracts. The fruit of this plant has strong anti-oxidant properties, helps the liver remove toxins, lowers cholesterol levels, and aids in digestion. Amla extract is reputed to have the highest concentration of Vitamin C of any naturally occurring substance.

Hawthorne Berry Extract (Crataegus oxycantha), available from Blue California, is primarily used as a cardiac tonic in herbal medicine. It is used to increases coronary blood flow and improve myocardial metabolism. It is believed to contain flavinoid compounds, which dilate blood vessels, and mildly reduce blood pressure.

Reishi Mushroom Extract (Ganoderma lucidum), available from Blue California, is a Chinese herb, which has an anti-histamine affect, and is also believed to stimulate the immune system. It is known for its ability to promote feelings increased energy and rejuvenation in individuals with long-term use.

Rhodiola Rosea Extract, available from Draco Natural Products, Inc., is used to promote physical and mental performance.

Rosemary Extract (Rosemarinus officinalis), available from Brucia Plant Extracts, is an herbal analgesic and anti-pyretic. It has been used as an herbal remedy to reduce high blood pressure, as a blood cleanser and as a antiseptic. It has also been used to reduce nervous headaches, alleviate migraines, and to improve memory.

Garlic Extract (Allium sativum), available from Mini Star International Inc., is an herbal antibiotic and blood-thinning agent with numerous uses and benefits in herbal medicine. It contains significant amounts of allium, and the trace minerals germanium and selenium that are missing in most diets. Garlic also appears to reduce LDL cholesterol, lower triglycerides, and increase HDL levels. In herbal medicine, garlic is also believed to have a detoxifying effect on the liver, and, as an immune stimulant.

Ginkgo Biloba Extract (Ginkgo biloba), available from Quality Botanical Ingredients Inc., improves age-related changes in cognitive functions. It has also been used to alleviate mild depression and improve performance in people with physical balance disorders.

Grape Seed Extract (Vitis vinifera), available from Blue California, contains proanthrocyanidin compounds, bioflavinoids which are effective antioxidants, work in concert with Vitamin C, and which may improve the maintenance of small blood vessels.

Jiaogulan Extract (Gynostemna pentaphyllum), available from Blue California, is used to lower cholesterol and help with the circulatory systems thus helping to reduce the risk of high blood pressure and other circulatory risks.

Ginger Extract (Zingiber officinalis), available from Triarco Industries, is an herb used for the digestive system. It can alleviate nausea and motion sickness and may have anti-ulcer effects.

Pipali Long Pepper Extract, available from Blue California, can be used for the improvement of the digestive system and is a source of capcasin.

Mixed Carotenoids (D. salina, sea algae) is a source of vitamin A, available from Cognis Corporation (Cincinnati, Ohio), which is an anti-oxidant. The mixed carotenoids also enhance immune function, aid the general cell structure of the body, and promote visual health and slow the degeneration of bones associated with aging.

Mixed tocopherols and tocotrienols, available from Eastman Chemical (Kingsport, Tenn.). In addition to providing vitamin E, which is a effective anti-oxidant, this ingredient also improves immunity, aids the general cell structure of the body, reduces the risk of skin damage from UV rays when taken with Vitamin C, and helps with joint mobility.

Coenzyme Q-10 (Ubidecarenone), available from Esai (Houston, Tex.) is a very powerful anti-oxidant that improves cardiac function, reduces high blood pressure, improves the functioning of the immune system, aids the general cell structure of the body, and helps prevent against mouth decay associated with aging.

Astaxanthin Complex, oil extract (Haematococcus sp., microalgae), available from Lahaye Lais (Redmond, Wash.) is an extremely potent anti-oxidant. It easily enters the central nervous system and helps with cell communication and protects against photic-induced injury. Astaxanthin also can enhance the immune system, aid the general cell structure of the body, is cardioprotective, and beneficial to lipoproteins.

Lutein (natural esters from marigold flowers), available from Cognis Corporation (Cincinnati, Ohio) are part of the carotenoids that enhance immune function and promote visual health.

Lycopene (from tomato oleoresin), available from Lyco-o-mato (Beer-Sheva, Israel) is a natural pigment found in tomatoes and other red fruit which has been shown to have significant anti-oxidant properties.

Preferably, compositions in accordance with the invention include several compounds of each type. Thus, a formulation in accordance with the present invention could include Vitamin C, Bilberry Extract, Chlorella, Green Tea Extract, mixed Carotenoids, mixed tocopherols and tocotrienols, and Coenzyme Q-10. Preferably, a formulation in accordance with the present invention would also include one or more of Alpha Lipoic acid, N-Acetyl-L-Cysteine, Amla extract, Hawthorne berry extract, Reishi mushroom extract, Rhodiola Rosea extract, Rosemary extract, Garlic extract, Ginkgo Biloba extract, Grape seed extract and Jiaogulan extract. More preferably, a formulation in accordance with the present invention would include each of Vitamin C, Bilberry Extract, Chlorella, Green Tea Extract, mixed Carotenoids, mixed tocopherols and tocotrienols, and Coenzyme Q-10, one or more of Alpha Liphoic acid, N-Acetyl-L-Cysteine, Amla extract, Hawthorne berry extract, Reishi mushroom extract, Rhodiola Rosea extract, Rosemary extract, Garlic extract, Ginkgo Biloba extract, Grape seed extract and Jiaogulan extract, and would further include one or more of Ginger extract, Pipali Long Pepper extract, Astaxanthin Complex, Lutein, and Lycopene. Most preferably, a formulation in accordance with the present invention would include each of Vitamin C, Bilberry Extract, Chlorella, Green Tea Extract, mixed Carotenoids, mixed tocopherols and tocotrienols, and Coenzyme Q-10, Alpha Liphoic acid, N-Acetyl-L-Cysteine, Amla extract, Hawthorne berry extract, Reishi mushroom extract, Rhodiola Rosea extract, Rosemary extract, Garlic extract, Ginkgo Biloba extract, Grape seed extract and Jiaogulan extract, Ginger extract, Pipali Long Pepper extract, Astaxanthin Complex, Lutein, and Lycopene.

The present invention is preferably formulated as a two-part composition. The first part, or first component, comprises a combination of lipid-soluble ingredients and the second part, or second component, comprises a combination of water-soluble ingredients. The lipid-soluble ingredients are preferably packaged in a soft gel cap and the water-soluble ingredients are preferably packaged in a hard shell capsule or a tablet.

A contemplated method of use of the present invention includes taking the two-part composition in accordance with a medically acceptable protocol. The preferred method involves taking two to four doses of the first component (i.e. soft gel cap containing lipid-soluble components) and two to four doses of the second component (i.e. hard shell capsule or tablet containing water-soluble components) daily. Optionally, additional doses can be taken. The doses can be taken in any combination, and at any time during the day. Thus for example, four doses (two doses of the lipid-soluble component and two doses of the water-soluble component) could be taken, at once, at any time during the day or else, four doses could be spread throughout the day. Preferably, four doses are taken at once or else a dose of the lipid-soluble component and a dose of the water-soluble component are taken together at the beginning of the day followed by another dose of the water-soluble component and another dose of the lipid-soluble component, taken together, later in the day. Accordingly, two soft gel caps and two hard shell capsules or tablets can be provided in a convenient one-serving packet and the four portions (i.e. two soft gel caps and two hard shell capsules or tablets) can be taken at one time or twice per day (i.e. half in the morning and half in the afternoon or evening).

A “dose” of lipid-soluble components is understood to mean a single soft gel capsule comprising lipid-soluble components. Alternatively, a “dose” of lipid-soluble components can be a combination of lipid-soluble active ingredients in accordance with the invention and in amounts described herein. Similarly, a “dose” of water-soluble components is understood to mean a single hard shell capsule or tablet comprising water-soluble components. Alternatively, a “dose” of water-soluble components can be a combination of water-soluble active ingredients in accordance with the invention and in amounts described herein.

The present invention further encompasses a composition and method for enhancing the preservation of collected blood products. Collection and storage of blood products is a vital component of modem medical practice. It is demonstrated that RBCs in blood collected from subjects deteriorate over time. It is further demonstrated that, in subjects ingesting a formulation of the present invention prior to giving blood, the RBCs in the collected blood degrade at a significantly slower rate than the RBCs in blood collected from subjects not ingesting a formulation of the present invention prior to giving blood. Hence, a formulation of the present invention is useful in the preservation of collected blood, and an embodiment of the present invention is also directed toward a method of preserving collected blood by the ingestion by blood donors of an antioxidant formulation of the present invention prior to donating blood. In an alternative embodiment, the useful lifespan of previously collected blood may be increased by the addition of a formulation of the present invention to the collected blood.

Therefore, an embodiment of this aspect of the present invention comprises a composition useful for the enhancement of the shelf-life of collected blood products. A formulation of the present invention as described above, or exemplified below is preferred. A method of using present inventive compositions for the preservation of collected blood products is a further embodiment of the present invention. An embodiment of the method of preserving blood products and/or enhancing the shelf-life of collected blood products provides for the ingestion by a blood donor of one to four doses each of the lipid soluble and water soluble components of an embodiment of the present inventive composition per day for one to seven days prior to donating blood. Preferably, the donor will two to four doses per day. Most preferably, the donor will ingest two to four doses per day for one week prior to donating blood.

Additionally, inasmuch as anemia is a condition defined by a shortage of RBCs, the present invention is useful in the treatment and prevention of anemia. By increasing the lifespan of individual RBCs, the total amount of RBCs in the blood of a person predisposed to anemic conditions is enhanced. Likewise, treatment of acute anemic conditions is affected by increasing the lifespan of the RBCs present in the user's blood, thus helping to prevent further aggravation of the anemic condition and increasing the speed at which the patient is able to rebuild his supply of RBCs through endogenous production.

Therefore, an embodiment of this aspect of the present invention provides a composition for the prevention and treatment of anemic conditions in a patient requiring such treatment. A formulation of the present invention as described above, or exemplified below is preferred. An embodiment of the method of treating and/or preventing anemia provides for a patient ingesting, or being administered, one to four doses each of the lipid soluble and water soluble components of an embodiment of the present inventive composition per day during the course of treatment. Most preferably, the patient will ingest two to four doses per day.

### EXAMPLES OF PREFERRED EMBODIMENTS

Examples of formulations in accordance with the invention are provided below. The exemplary formulations contain synthetic and/or natural components which can have beneficial and cumulative effects upon the immune, circulatory and central nervous systems in the human body. To aid delivery and uptake when ingested, these component are formulated into a tablet or hard shell capsule containing water-soluble ingredients and a soft gel cap containing lipid-soluble ingredients.

The examples below list only the active ingredients contained in the capsules. Other ingredients commonly used in packaging ingredients into soft gel capsules or hard shell capsules or tablets will be recognized by persons of ordinary skill in the art. Other ingredients commonly used in formulating dietary supplements include, for example, fillers, excipients, flavorings, dyes, carriers and binders. For example, in a preferred embodiment of the invention, the hard shell capsules or tablets, in addition to active ingredients, also include Magnesium Stearate, Silicon Dioxide and Gelatin, and the soft gel capsules include, in addition to the active ingredients, an oil-base, Glycerin, Beeswax, Water, Caramel, and Lecithin. The oil base can be, for example, a vegetable, mineral, olive, or fish oil, and is preferably wheat germ oil.

It should be understood as well, that the examples below are not limiting. For example, in addition to the ingredients or amounts used in the examples below, other suitable ingredients or amounts include L-Camitine (60 mg), Sage (15 mg), Ashwaganda (100 mg), Pine Bark (50 mg), Elderberry (75 mg), Zinc (50 mg), Tumeric (150 mg), Dark Chocolate (75 mg), Thyme (15 mg), Basil (15 mg), Oregano (15 mg), Schisandra Berry (75 mg), Raspberry (75 mg), Strawberry (75 mg), Pomegranate (75 mg), Echinacea (50 mg), and Goldenseal (50 mg). Those ingredients could be added as additional ingredients to the examples below, or else as substitutions for ingredients in the examples below. For example, as a source of Vitamin C, Schisandra Berry, Raspberry, Strawberry, Pomegranate or Elderberry, or a combination thereof could replace some or all of the Vitamin C in the exemplified compositions. Zinc and/or Selenium are suitable replacements for some or all of the mixed tocopherols and tocotrienols. Blueberry could replace some or all of the Billberry. L-Carnitine, Sage, Thyme, Basil, Tumeric, Oregano or combinations thereof are suitable alternatives for some or all of the Reishi Mushroom and/or Rhodiola Rosea. Sage, Thyme, Basil, Tumeric, and Oregano, or combinations thereof are also suitable alternatives for some or all of the Ginger, Pipali Pepper, Garlic and/or Rosemary, whereas L-Carnitine is also a suitable alternative for some or all of the Lycopene. Dark Chocolate is a suitable replacement for some or all of the Green Tea, Ginseng is a suitable replacement for some or all of the Gingko Biloba, Pine Bark is a suitable replacement for some or all of the Grape Seed extract, and Ashwaganda, Echinacea, Goldenseal or a combination thereof are suitable alternatives for some or all of the Lutein. Echinacea and Goldenseal or a combination thereof are also suitable alternatives for some or all of the mixed Carotenoids, whereas Ashwaganda is also a suitable alternative for some or all of the Jiaogulan.

As is exemplified above, water-soluble ingredients can be alternatives for lipid-soluble ingredients and vice versa. In practice this means, for example, if a lipid-soluble ingredient is completely replaced with a water-soluble ingredient, the soft gel capsule will no longer include the lipid-soluble ingredient, but instead the hard shell capsule or tablet will include the replacement (water-soluble) ingredient. In other words, if 100 mg Ashwaganda were to be used rather than the 3 mg of Lutein in the formulation according to example 4, below, the soft gel capsule would contain neither Lutein nor Ashwaganda, rather the hard shell capsule or tablet would contain Ashwaganda.

The amounts of each vitamin or herbal nutrient were selected to be sufficient to provide positive beneficial effects but still be well under toxicity levels when ingested as directed. The amounts presented below and elsewhere in this specification are preferred amounts but they can be adjusted, up or down, by about 20%. Thus when an amount of 80 mg is indicated, it is understood that amount can range from about 64 mg to about 96 mg. Further, it is also understood that the word “about” modifies each of the amounts listed below and in elsewhere in this specification, even where not explicitly indicated. Thus, 80 mg Co-Q-Enzyme implies “about” 80 mg. The word “about” is used to accommodate for errors inherent in measuring amounts of ingredients and to stress the flexibility (e.g. +/−20%) associated with each numerical value.

It is further understood that when a ratio is presented in connection with an extract it is understood that the ratio is the total amount of ingredient to total amount of active ingredient. Thus for example, Bilberry extract, 4:1, 100 mg indicates that out of the 100 mg, about 25 mg is active ingredient.

### Example 1

Hard Shell Capsule/Tablet (per 2)

| | | |
|---|---|---|
| Vitamin C (as Magnesium Ascorbate) | 200 | mg |
| Alpha Lipoic Acid | 100 | mg |
| Bilberry Extract, 4:1 (Vaccinium myrtillus) (berry) | 100 | mg |
| Chlorella (Broken Cell) | 100 | mg |
| Green Tea Extract, 4:1 (Thea sinensis) (leaf) | 100 | mg |

Soft Gel Capsule (per 2)

| | | |
|---|---|---|
| Mixed Carotenoids (D. salina, sea algae) 2 mg provides: | | |
| Vitamin A (as beta carotene) | 1,000 | IU |
| Mixed tocopherols and tocotrienols blend; 100 mg provides: | | |
| Vitamin E (as tocopherol) | 10 | IU |
| total tocotrienols | 16 | mg |
| Coenzyme Q-10 (bidecarenone) | 60 | mg |

### Example 2

A second formulation according to the present invention includes the same components as example 1, except that the Alpha Liphoic acid is replaced with an additional 100 mg of Bilberry extract, 4:1.

### Example 3

A third formulation according to the present invention is the same as that of example 1, except that the hard shell capsule or tablet (per 2) includes the following additional ingredients:

| | |
|---|---|
| N-Acetyl-L-Cysteine | 75 mg |
| Amla Extract, 5:1 (Emblica officinalis) (fruit) | 75 mg |
| Hawthorne Berry Extract, 4:1 (Crataegus oxycantha) (berry) | 75 mg |
| Reishi Mushroom Extract, 4:1 (Ganoderma lucidum) (fungus) | 75 mg |
| Rhodiola Rosea Extract, 4:1 (standardized to 1% salidroside) | 75 mg |
| Rosemary Extract, 4:1 (Rosemarinus officinalis) (leaf) | 75 mg |
| Garlic Extract, 3:1 (Allium sativum) (bulb) | 75 mg |
| Ginkgo Biloba Extract, 4:1 (Ginkgo biloba) (leaf) | 50 mg |
| Grape Seed Extract, 4:1 (Vitus vinifera) (seed) | 50 mg |
| Jiaogulan Extract, 4:1 (Gynostemna pentaphyllum) (whole herb) | 50 mg |

### Example 4

A fourth formulation in accordance with the invention is the same as that of example 3, except that the hard shell capsule or tablet and the soft gel capsule include the additional ingredients listed below.

Hard Shell Capsule or Tablet (per 2)

| | |
|---|---|
| Ginger Extract, 4:1 (Zingiber officinalis) (root) | 15 mg |
| Pipali Long Pepper Extract, 4:1 (Piper longum) (fruit) | 15 mg |

Soft Gel Capsule (per 2)

| | |
|---|---|
| Astaxanthin Complex, oil extract (Haematococcus sp.) | 10 mg |
| (microalgae) | |
| Lutein (natural esters from marigold flowers) | 3 mg |
| Lycopene (from tomato oleoresin) | 3 mg |

### Example 5

Hard Shell Capsule/Tablet (per 2)

| | | |
|---|---|---|
| Vitamin C (as Magnesium Ascorbate) | 200 | mg |
| Alpha Lipoic Acid | 100 | mg |
| Blueberry Extract, 4:1 (Vaccinium corymbosum) (berry) | 100 | mg |
| Chlorella (Broken Cell) | 100 | mg |
| Green Tea Extract, 4:1 (Thea sinensis) (leaf) | 100 | mg |
| N-Acetyl-L-Cysteine | 75 | mg |
| Amla Extract, 4:1 (Emblica officinalis) (fruit) | 75 | mg |
| Hawthorne Berry Extract, 4:1 (Crataegus oxycantha) (berry) | 75 | mg |
| Reishi Mushroom Extract, 4:1 (Ganoderma lucidum) (fungus) | 75 | mg |
| Rhodiola Rosea Extract, 4:1 (standardized to 1% salidroside) | 75 | mg |
| Rosemary Extract, 4:1 (Rosemarinus officinalis) (leaf) | 75 | mg |
| Garlic Extract, 3:1 (Allium sativum) (bulb) | 75 | mg |
| Ginkgo Biloba Extract, 4:1 (Ginkgo biloba) (leaf) | 50 | mg |
| Grape Seed Extract, 4:1 (Vitus vinifera) (seed) | 50 | mg |
| Jiaogulan Extract, 4:1 (Gynostemna pentaphyllum) | 50 | mg |
| (whole herb) | | |
| Ginger Extract, 4:1 (Zingiber officinalis) (root) | 15 | mg |
| Pipali Long Pepper Extract, 4:1 (Piper longum) (fruit) | 15 | mg |

Soft Gel Capsule (per 2)

| | | |
|---|---|---|
| Mixed Carotenoids (D. salina, sea algae) 2 mg provides: | | |
| Vitamin A (as beta carotene) | 1,000 | IU |
| Mixed tocopherols and tocotrienols blend; 100 mg provides: | | |
| Vitamin E (as tocopherol) | 10 | IU |
| total tocotrienols | 16 | mg |
| Coenzyme Q-10 (bidecarenone) | 80 | mg |
| Astaxanthin Complex, oil extract (Haematococcus sp.) | 10 | mg |
| (microalgae) | | |
| Lutein (natural esters from marigold flowers) | 3 | mg |
| Lycopene (from tomato oleoresin) | 3 | mg |

### Example 6

A sixth formulation in accordance with the invention uses a soft gel cap containing the same lipid-soluble active components as in example 5. The hard shell tablet containing water-soluble active components, however, includes 100 mg Bilberry extract (per 2) rather than 100 mg Blueberry extract.

### Example 7

Hard Shell Capsule/Tablet (per 2)

| | | |
|---|---|---|
| Vitamin C (as Magnesium Ascorbate) | 200 | mg |
| Alpha Lipoic Acid | 100 | mg |
| Blueberry Extract, 4:1 (Vaccinium corymbosum) (berry) | 100 | mg |
| Chlorella (Broken Cell) | 100 | mg |
| Green Tea Extract, 4:1 (Thea sinensis) (leaf) | 100 | mg |
| N-Acetyl-L-Cysteine | 75 | mg |
| Amla Extract, 4:1 (Emblica officinalis) (fruit) | 75 | mg |
| Hawthorne Berry Extract, 4:1 (Crataegus oxycantha) (berry) | 75 | mg |
| Reishi Mushroom Extract, 4:1 (Ganoderma lucidum) (fungus) | 75 | mg |
| Rhodiola Rosea Extract, 4:1 (standardized to 1% salidroside) | 75 | mg |
| Rosemary Extract, 4:1 (Rosemarinus officinalis) (leaf) | 75 | mg |
| Tumeric (standard extract) (Curcuma longa) | 75 | mg |
| Garlic Extract, 3:1 (Allium sativum) (bulb) | 75 | mg |
| Ginkgo Biloba Extract, 4:1 (Ginkgo biloba) (leaf) | 50 | mg |
| Grape Seed Extract, 4:1 (Vitus vinifera) (seed) | 50 | mg |
| Jiaogulan Extract, 4:1 (Gynostemna pentaphyllum) | 50 | mg |
| (whole herb) | | |
| Ginger Extract, 4:1 (Zingiber officinalis) (root) | 15 | mg |
| Pipali Long Pepper Extract, 4:1 (Piper longum) (fruit) | 15 | mg |

Soft Gel Capsule (per 2)

| | | |
|---|---|---|
| Mixed Carotenoids (D. salina, sea algae) 2 mg provides: | | |
| Vitamin A (as beta carotene) | 2,000 | IU |
| Mixed tocopherols and tocotrienols blend; 200 mg provides: | | |
| Vitamin E (as tocopherol) | 20 | IU |
| total tocotrienols | 32 | mg |
| Coenzyme Q-10 (bidecarenone) | 80 | mg |
| Astaxanthin Complex, oil extract (Haematococcus sp.) | 20 | mg |
| (microalgae) | | |
| Lutein (natural esters from marigold flowers) | 5 | mg |
| Lycopene (from tomato oleoresin) | 5 | mg |

### Example 8

Hard Shell Capsule/Tablet (per 2)

| | | |
|---|---|---|
| Vitamin C (as Magnesium Ascorbate) | 250 | mg |
| Alpha Lipoic Acid | 100 | mg |
| Billberry Extract, 4:1 (Vaccinium myrtillus) (berry) | 200 | mg |
| Tumeric (standard extract) (Curcuma longa) | 100 | mg |
| Green Tea Extract, 4:1 (Thea sinensis) (leaf) | 125 | mg |
| N-Acetyl-L-Cysteine | 80 | mg |
| Amla Extract, 4:1 (Emblica officinalis) (fruit) | 50 | mg |
| Spinach Powder | 40 | mg |
| Tomato Powder | 40 | mg |
| Pine Tree Bark extract, 4:1 | 30 | mg |
| Rosemary Extract, 4:1 (Rosemarinus officinalis) (leaf) | 75 | mg |
| Zinc (monomethionone) | 20 | mg |
| Garlic Extract, 3:1 (Allium sativum) (bulb) | 75 | mg |
| Ginkgo Biloba Extract, 4:1 (Ginkgo biloba) (leaf) | 40 | mg |
| Grape Seed Extract, 4:1 (Vitus vinifera) (seed) | 40 | mg |
| Elderberry, 4:1 | 40 | mg |
| Selenium (L seleno methionone) | 60 | mg |

Soft Gel Capsule (per 2)

| | | |
|---|---|---|
| Mixed Carotenoids (D. salina, sea algae) 2 mg provides: | | |
| Vitamin A (as beta carotene) | 2,000 | IU |
| Mixed tocopherols and tocotrienols blend; 200 mg provides: | | |
| Vitamin E (as tocopherol) | 200 | IU |
| total tocotrienols | 32 | mg |
| Lutein | 5 | mg |
| Lycopene | 5 | mg |
| Coenzyme Q-10 (bidecarenone) | 80 | mg |
| Astaxanthin Complex, oil extract (Haematococcus sp.) | 20 | mg |
| (microalgae) | | |

### Example 9

A ninth formulation in accordance with the invention uses a soft gel cap containing the same lipid-soluble active components as in example 7, except that the amount of mixed Carotenoids is 3000 IU (per 2) rather than 2000 IU. The hard shell tablet containing water-soluble active components includes the following ingredients:

| | | |
|---|---|---|
| Vitamin C (as Magnesium Ascorbate) | 200 | mg |
| Alpha Lipoic Acid | 100 | mg |
| Blueberry Extract, 4:1 (Vaccinium corymbosum) (berry) | 200 | mg |
| Tumeric (standard extract) (Curcuma longa) | 75 | mg |
| Green Tea Extract, 4:1 (Thea sinensis) (leaf) | 100 | mg |
| N-Acetyl-L-Cysteine | 75 | mg |
| Amla Extract, 4:1 (Emblica officinalis) (fruit) | 50 | mg |
| Spinach Powder | 50 | mg |
| Tomato Powder | 50 | mg |
| Reishi Mushroom Extract, 4:1 (Ganoderma lucidum) (fungus) | 75 | mg |
| Rosemary Extract, 4:1 (Rosemarinus officinalis) (leaf) | 75 | mg |
| Ashwugandha, 4:1 (Withania somniferum) | 50 | mg |
| Garlic Extract, 3:1 (Allium sativum) (bulb) | 75 | mg |
| Ginkgo Biloba Extract, 4:1 (Ginkgo biloba) (leaf) | 50 | mg |
| Grape Seed Extract, 4:1 (Vitus vinifera) (seed) | 50 | mg |
| Elderberry, 4:1 | 50 | mg |
| Jiaogulan Extract, 4:1 (Gynostemna pentaphyllum) | 50 | mg |
| (whole herb) | | |
| Ginger Extract, 4:1 (Zingiber officinalis) (root) | 10 | mg |
| Pipali Long Pepper Extract, 4:1 (Piper longum) (fruit) | 10 | mg |
| Panax Ginseng, 4:1 | 50 | mg |
| Hawthorne Berry Extract, 4:1 (Crataegus oxycantha) (berry) | 50 | mg |

### DEMONSTRATION OF USE OF THE INVENTION

A comparison was made between the present invention and antioxidant formulations of the prior art. It may be seen from this example that the present invention is a significant improvement over the prior art in its ability to prevent the adverse effects of free radical-induced cell deterioration.

Four different conditions of dietary supplementation were studied: (1) baseline control: no dietary supplements whatsoever; (2) 100 IU vitamin E (GNC Natural E 100); (3) 150 mg green tea extract, (GNC Herbal Plus Standardized Green Tea (Camellia sinensis, standardized for 80% polyphenols (120 mg)); and, (4) one daily serving of a preferred embodiment of the invention known as Total Rejuvenation (TR).

The following four subjects participated in the trial, identified herein only by subject number, initials, age, gender, and smoking habits:

1. J H, 56, female nonsmoker;

2. B F, 40, male nonsmoker;

3. K G, 57, female smoker;

4. D K, 47, male nonsmoker.

Both smokers had smoked at least 1 pack of cigarettes daily for 35 years. The nonsmokers had never smoked cigarettes.

Blood testing of all four subjects was performed initially, to provide a baseline control, and following one week after consuming each of the following dietary supplements at breakfast:

1. 100 IU vitamin E

2. 150 mg standardized green tea extract

3. Daily serving of Total Rejuvenation.

After each blood test, each subject was given a different supplement to take for the next week, and then returned for another blood test. All subjects took the supplements in the same order, from 1 to 3, as listed above, for 3 weeks. In this way, each subject had 4 blood tests, 1 week apart, including the initial baseline testing.

Subjects were asked to make no other changes in diet, supplementation, smoking behavior, or other lifestyle habits for the duration of the trial. Subjects were also interrogated at the start of each blood test to ascertain whether they complied with this request, and whether they took the supplement as indicated each day.

Each subject served as their own control in the study; that is, baseline results were compared to the results obtained when each subject took a particular dietary supplement. Smokers were also compared to nonsmokers.

All supplements were in the form of hard gelatin capsules containing powdered nutrients or soft gelatin capsules containing liquid nutrients. A single capsule was used as one serving in the case of vitamin E and green tea extract. Two soft and two hard gelatin capsules constituted one daily serving of Total Rejuvenation. No placebo controls were employed in the study.

Each subject was told to take the supplement at breakfast. Five to six hours later, a droplet of blood was removed from a subject's fingertip using an automatic lancet device and placed onto a 24×50 mm glass microscope coverslip. This was gently placed onto a pre-cleaned glass microscope slide. Blood samples were prepared in duplicate. The time of blood draw was recorded and marked the initial time (t=0) of the assay. The live blood sample was observed in the center of the slide. The samples were assayed photographically every 30 minutes over the next 3 hours using a dark-field microscope with video-enhancement, to view and record photographic images of RBC morphology over time. This method is frequently used in clinical nutritional assessment and has been referred to as dark-field live blood analysis.

The numbers of normal, crenated, and ghost RBCs were visually discerned and counted from each photograph. The values were averaged for the two blood samples. The percentage of each type of RBC form at each time point is also calculated.

The results are shown for each subject as follows.

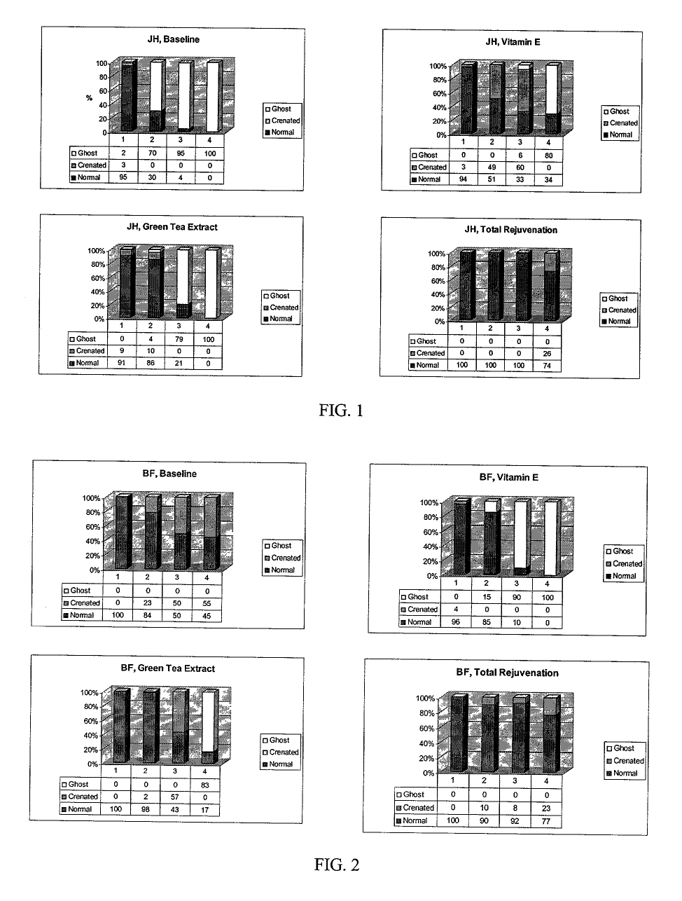

A. J H, 56, female nonsmoker. FIG. 1 shows the percentage of RBCs that appear normal in shape, crenated, and ghosts (1) initially; (2) 1 hour; (3) 2 hours; and (4) 3 hours from the time of blood draw (t=0) for the 4 conditions of the study. The baseline for this subject shows that there is a strong tendency toward ghosting of RBCs. 70% of RBCs were ghosts at 1 hour, and 100% were ghosts at 3 hours. Vitamin E delayed this tendency, such that only 6% were ghosts at 2 hours, and 80% at 3 hours. Green tea extract showed little protective effect on the subject's RBCs, as 79% were ghosts at 2 hours and 100% at 3 hours. Total Rejuvenation prevented ghosts for 3 hours, although 26% crenation was observed at 3 hours.

B. B F, 40, male nonsmoker. FIG. 2 shows the percentage of RBCs that appear normal in shape, crenated, and ghosts (1) initially; (2) 1 hour; (3) 2 hours; and (4) 3 hours from the time of blood draw (t=0) for the 4 conditions of the study. The baseline for this subject shows that there is a tendency toward crenation of RBCs, as 55% of them were ghosts at 3 hours. Vitamin E supplementation reduced this tendency toward crenation, but was associated instead with greater numbers of ghosts, with 100% conversion to ghosts observed at 3 hours. Green tea extract showed little or no protective effect on the RBCs. Total Rejuvenation prevented ghosts for up to 3 hours, although 8 to 23% crenation was observed from 1 to 3 hours, respectively.

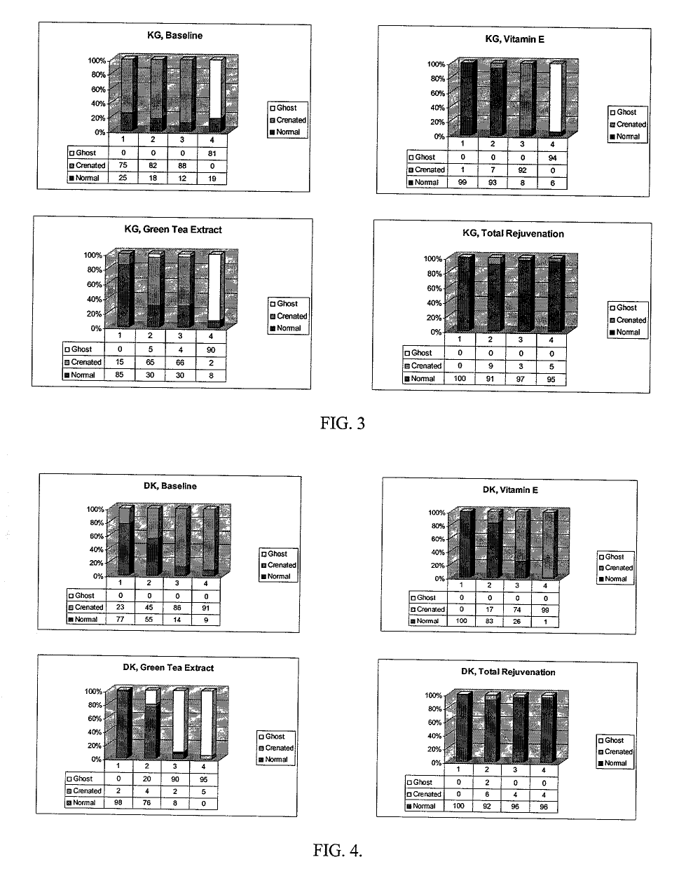

C. K G, 57, female smoker. FIG. 3 shows the percentage of RBCs that appear normal in shape, crenated, and ghosts (1) initially; (2) 1 hour; (3) 2 hours; and (4) 3 hours from the time of blood draw (t=0) for the 4 conditions of the study. The baseline shows that this subject's RBCs are unstable with a tendency toward crenation. Upon initial examination, 75% of RBCs were already crenated. Vitamin E afforded some protection from crenation for 1 hour, and then the cells were seen to be subject to both crenation and ghosting. Green tea extract protected the RBCs only slightly when compared to baseline. Total Rejuvenation apparently prevented both extensive crenation and ghosting, such that at 3 hours, 95% of the RBCs appeared normal.

D. D K, 47, male smoker. FIG. 4 shows the percentage of RBCs that appear normal in shape, crenated, and ghosts (1) initially; (2) 1 hour; (3) 2 hours; and (4) 3 hours from the time of blood draw (t=0) for the 4 conditions of the study. The baseline shows a tendency toward crenation for this subject's RBCs, with 23% of the cells initially crenated, and 91% crenated after 3 hours. Vitamin E was shown to have some effect on the RBCs, with only 17% crenation after 1 hour, and 74% after 3 hours. Green tea extract was associated with ghosting for this subject, with 90% of the RBCs observed to be ghosts after 2 hours. Total Rejuvenation was shown to have the most stabilizing effect on this subject's RBCs, with only 4 to 6% crenation over time; the remainder of the cells appeared normal in morphology when the subject was taking this supplement.

The results of this study indicate that the present invention is effective. Both vitamin E at 100 IU and green tea extract (150 mg, standardized) were found to exhibit a small protective effect on the stability of RBCs in blood that was removed from the fingertips of 4 volunteer subjects who consumed the dietary supplements for 1 week prior to blood draw. A formulation of the present invention, however, was observed to be superior to both vitamin E and to green tea extract in protecting RBCs from morphology changes typically associated with free radical attack and oxidation. More than 90% of the RBCs of all 4 subjects taking a formulation of the present invention retained their normal cell shape for at least 2 hours after the blood was drawn. Moreover, there was no apparent difference in the effects of the formulation of the present invention on smokers vs. nonsmokers; that is, a comparable degree of protection on RBC morphology was observed for both, despite the fact that smokers may be exposed to greater oxidative stress than nonsmokers.

These results consistently demonstrate a positive effect of antioxidant dietary supplements to preserve RBC morphology in blood samples removed from the peripheral circulation observed over time. The present invention was found to be superior in stabilizing RBC morphology over and above two of its components, namely, vitamin E and green tea extract.

This study supports the concept that the dietary supplement of the present invention, consumed daily, will help combat aging at the cellular level. In accordance with this, it was observed that aging due to oxidative damage in peripheral blood smears, as assayed by RBC morphology, was slower for subjects taking a formulation of the present invention than vitamin E alone, green tea extract alone, or no dietary supplements whatsoever.

A person of ordinary skill will appreciate that changes could be made to the embodiments described above without departing from the broad inventive concept thereof. It is understood, therefore, that this invention is not limited to the particular embodiments disclosed, but it is intended to cover modifications within the spirit and scope of the invention.

What is claimed is:

1. A composition, comprising:
a first portion and a second portion;
wherein the first portion comprises: at least one first component chosen from Vitamin C, Schisandra Berry, Raspberry, Strawberry, Pomegranate, and Elderberry; at least one second component chosen from Bilberry and Blueberry; and at least one third component chosen from Green Tea and Dark Chocolate; and
wherein the second portion comprises: at least one first component chosen from mixed Carotenoids, Echinacea, and Goldenseal; at least one second component chosen from mixed tocopherols and tocotrienols, Zinc, and Selenium; and a third component Coenzyme Q-10.

2. A composition according to claim 1, wherein the first portion further comprises Alpha Liphoic acid and Chlorella.

3. A composition according to claim 2, wherein the first portion further comprises at least one additional component chosen from N-Acetyl-L-Cysteine, Amla extract, Hawthorne Berry extract, Reishi Mushroom extract, Rhodiola Rosea extract, Garlic extract, Ginkgo Biloba extract, Grape Seed extract, Jiaogulan extract, L-Carnitine, Sage, Thyme, Basil, Tumeric, Oregano, Ginseng, and Pine Bark.

4. A composition according to claim 3, wherein the first portion further comprises at least one additional component chosen from Ginger extract, Pipali Long Pepper, Spinach Powder, and Tomato Powder.

5. A composition according to claim 4, wherein the second portion further comprises at least one additional component chosen from Astaxanthin, Lutein, and Lycopene.

6. A composition according to claim 1, wherein the mixture of Carotenoids also comprises Lutein and Lycopene.

7. A composition according to claim 5, wherein the at least one first component of the first portion is Vitamin C, the at least one second component of the first portion is Bilberry extract, the at least one third component of the first portion is Green Tea extract and the first portion further comprises Alpha Lipoic acid, Chlorella, N-Acetyl-L-Cysteine, Amla extract, Hawthorne Berry extract, Reishi Mushroom extract, Rhodiola Rosea extract, Rosemary extract, Garlic extract, Ginkgo Biloba extract, Grape Seed extract, Jiaogulan extract, Ginger extract, and Pipali Long Pepper extract; and
wherein the at least one first component of the second portion is mixed Carotenoids, the at least one second component of the second portion is mixed tocopherols and tocotrienols, and the second portion further comprises Astaxanthin, Lutein, and Lycopene.

8. A composition according to claim 1, wherein the first portion is packaged as a hard shell capsule or tablet and the second portion is packaged as a soft gel capsule.

9. A method for resisting the effects of the aging process, comprising:
ingesting or administering a composition of claim 1.

10. The method of claim 9 wherein the composition is a two-part nutritional supplement, wherein the two-part nutritional supplement comprises: a first portion and a second portion, wherein the first portion comprises at least one first component chosen from Vitamin C, Schisandra Berry, Raspberry, Strawberry, Pomegranate, and Elderberry; at least one second component chosen from Bilberry and Blueberry; and at least one third component chosen from Green Tea and Dark Chocolate; and wherein the second portion comprises at least one first component chosen from mixed Carotenoids, Echinacea, and Goldenseal; at least one second component chosen from mixed tocopherols and tocotrienols, Zinc, and Selenium; and a third component Coenzyme Q-10.

11. The method of claim 9 wherein at least two doses of the first portion and at least two doses of the second portion are ingested or administered per day.

12. A method for enhancing the shelf-life of blood products comprising: administering daily to a blood donor for one to seven days prior to donating blood the composition of claim 1.

13. The method of claim 11 wherein said composition is a two-part nutritional supplement, wherein the two-part nutritional supplement comprises: a first portion and a second portion, wherein the first portion comprises at least one first component chosen from Vitamin C, Schisandra Berry, Raspberry, Strawberry, Pomegranate, and Elderberry; at least one second component chosen from Bilberry and Blueberry; and at least one third component chosen from Green Tea and Dark Chocolate; and wherein the second portion comprises at least one first component chosen from mixed Carotenoids, Echinacea, and Goldenseal; at least one second component chosen from mixed tocopherols and tocotrienols, Zinc, and Selenium; and a third component Coenzyme Q-10.

14. The method of claim 12 wherein the period of administration is three to seven days prior to donating blood.

15. The method of claim 12 wherein at least two doses of the first portion and at least two doses of the second portion are administered per day.

16. A method for preventing anemia in a person predisposed to an anemic condition comprising:
ingesting or administering daily a composition of claim 1.

17. The method of claim 15 wherein the composition is a two-part nutritional supplement, wherein the two-part nutritional supplement comprises: a first portion and a second portion, wherein the first portion comprises at least one first component chosen from Vitamin C, Schisandra Berry, Raspberry, Strawberry, Pomegranate, and Elderberry; at least one second component chosen from Bilberry and Blueberry; and at least one third component chosen from Green Tea and Dark Chocolate; and wherein the second portion comprises at least one first component chosen from mixed Carotenoids, Echinacea, and Goldenseal; at least one second component chosen from mixed tocopherols and tocotrienols, Zinc, and Selenium; and a third component Coenzyme Q-10.

18. The method of claim 15 wherein at least two doses of the first portion and at least two doses of the second portion are ingested or administered per day.
